(19) United States
(12) Patent Application Publication
(10) Pub. No.: US 2026/0300249 A1
(43) Pub. Date: Oct. 1, 2026

(54) DATABASE OPERATION REVERSE ENGINEERING

(71) Applicant: T-Mobile USA, Inc., Bellevue, WA (US)

(72) Inventors: Arin Banerjee, Kent, WA (US); Prasad Changole, Issaquah, WA (US); Chaitanya Laxminarayana, Austin, TX (US)

(21) Appl. No.: 19/094,210

(22) Filed: Mar. 28, 2025

(51) Int. Cl. G06F 16/22

(52) U.S. Cl. CPC G06F 16/2282

(57) ABSTRACT

This disclosure relates to reverse engineering. Some implementations relate to monitoring database activity in order to reverse engineer operations used to populate one or more database tables. The techniques herein can monitor individual transactions, results of transactions, and/or the like, which can be used for reverse engineering. Some implementations relate to simplifying processes used to populate database tables and/or to reduce reliance on intermediate tables. Some implementations utilize machine learning for reverse engineering.

### BACKGROUND

Data loading, extracting, transforming, filtering, and so forth play an important role in a wide variety of industries. For example, data can be used to generate reports used for making business decisions, to aid in making medical decisions, and so forth. Often, organizations, groups, or even individuals within an organization, will have a need for data that has a particular format, is combined in a particular manner, is filtered in a particular manner, etc. This can lead to a proliferation of database tables, scripts, spreadsheets, text files, and so forth. Over time, problems can arise as data sources are changed or deprecated, security measures are altered, workers leave their jobs or change roles, APIs are modified, external service providers are changed or removed, and so forth. This can leave organizations with reports, applications, and so forth that no longer function as expected. Accordingly, there is a need for approaches that can help organizations understand data manipulation processes.

### BRIEF DESCRIPTION OF THE DRAWINGS

Detailed descriptions of implementations of the present invention will be described and explained through the use of the accompanying drawings.

FIG. 1 is a block diagram of an example transformer.

FIG. 2 is a block diagram that illustrates using secondary tables and source tables to determine information for a target table according to some implementations.

FIG. 3 is a diagram that shows an example using a machine learning model to analyze database activity according to some implementations.

FIG. 4 is a flowchart that illustrates an example reverse engineering process according to some implementations.

FIG. 5 is a flowchart that illustrates an example delay prediction process according to some implementations.

FIG. 6 is a flowchart that illustrates an example process for analyzing queries and determining if there is a need/benefit for additional tables, fields, or both according to some implementations.

FIG. 7 illustrates an example of transformations that can be performed in some implementations.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Developers, analysts, and other users (generally referred to herein as developers or users) often create applications, reports, dashboards, etc., (generally referred to as applications) that rely on data from one or more sources. Such data may undergo various processing operations, such as transformations, aggregations, filtering, and so forth. When there is a need for data to be transformed or aggregated in a particular manner, a developer may rely on data from multiple data sources. In some cases, a data source can depend upon data in one or more other data sources. Data sources that rely on other data sources are referred to as intermediate tables or intermediate data sources herein. For example, a developer who needs information about active customers may create a target table by pulling data from a marketing database table. The marketing database table can be an intermediate table that is constructed by pulling data from a billing or account management database table. The billing or account management database table can be considered a source of truth (referred to herein as a source table). The marketing table may include a copy of one or more columns present in the source table, but this may not be the case. For example, an account management database table may include all active customers, regardless of whether or not their payments are current, while the marketing database table may exclude customers who are behind on their bills because those customers are not typically the targets of marketing activities. It can be significant to pull data from a source table and to understand the transformations needed to achieve a final result in a target table from the source table. However, it may be unknown how to get from the source table to the desired output (e.g., from the source database table to the target database table). For example, it may be unknown how an intermediate table that the target table relies on is constructed from a source table. In some cases, different business units may be unwilling to share such information with one another or may lack sufficient resources to dedicate time to helping other business units or teams with their projects, or internal policies may not allow significant collaboration. In some cases, such information may not exist. Processes tend to evolve over time, and in many cases, there may not be any available documentation. This can be especially true for processes that are used primarily for internal business purposes and created without much or any consideration for maintainability or consistency over time.

While reference is made throughout this disclosure to target tables (or equivalently, target database tables), it will be appreciated that a target table can be a table stored in a database, a file stored to disk, a file stored in memory, or a temporary data object or set of data objects created as part of an executable process (e.g., as part of a script or binary executable running on a computing system) that is not retained after the executable process is complete.

While creating new datasets is a common task, a lack of knowledge of how certain processes work can also present a problem in other scenarios. For example, in some cases, developers may have a need to understand how an existing application, report, etc., operates. Existing applications may have documentation that is incomplete, incorrect, or outdated. In some cases, there may not be available documentation to consult to understand how the application, report, etc., works, where it pulls data from, how it transforms data, and so forth. For example, within an organization, applications, reports, and so forth are often developed in an ad hoc manner with little or no documentation. Moreover, any documentation that does exist may not be properly stored, labeled, etc., resulting in it being lost over time. A lack of documentation or institutional knowledge can be particularly problematic over longer periods of time, as users who created the application, report, etc., may leave the organization, taking their knowledge with them. This lack of knowledge can present a significant problem when a process breaks or produces incorrect outputs, when there is a need to migrate an application or report (e.g., due to IT configuration changes), and so forth.

While utilizing source tables can have certain advantages as described herein, there can be downsides to over-reliance on source tables. For example, relying on data sources other than source tables can offer advantages in some circumstances. For example, if a marketing department regularly needs a list of customers who are current on their bill, it can be useful to have a database table that includes such information, rather than executing a query against a source table every time such information is needed, which can delay data availability, cause excessive and unnecessary loads on computing resources, and so forth. However, relying on non-source-of-truth data can also have significant drawbacks, such as increased computational costs or longer execution times. For example, an application that needs all active subscribers may be less efficient if it pulls active subscribers with paid-up accounts from a marketing database table, pulls delinquent accounts from a collections database table, and then merges these results to create a table of all active subscribers, as opposed to pulling all the needed account information from a single source table that includes all active accounts.

Inefficient processes can have significant impacts. When database services are run on premises or in data centers under the control of the business, inefficient processes can slow down execution and make it take longer to get results, or can result in companies needing to purchase additional hardware to handle workloads. Migrations to cloud services also present an increased motivation for improved efficiency, as cloud service providers typically charge based on usage. Thus, executing needless queries or having inefficient processes can have significant financial impacts. Inefficiencies can also have a significant environmental impact. For example, more energy may be required to execute inefficient processes, additional hardware may need to be purchased, and so forth. Even in the case of on-premises servers or servers located in third-party data centers but owned or controlled by a company, inefficient processes have significant financial impacts as more servers, higher hardware specifications, greater electricity usage, and so forth may be needed to keep processes running smoothly.

The approaches herein provide ways to understand existing processes and improve such processes, which can provide many advantages such as reduced error rates, reduced computational demands, higher reliability, higher explainability, and so forth.

### Reverse Engineering

As described herein, the development of applications, reports, and so forth often takes place over time. In some cases, a report or application may be developed that utilizes information from databases that provide useful information but which should not be considered a source of truth or which should not be relied upon because they may change or become unavailable over time. For example, within a financial institution, a risk group may create a database table that is suited to their needs. A pricing group may access the same table, but the risk group may change the table over time to tailor it for their specific purposes, or may even abandon the table in favor of a different table or because there is no longer a need within the risk group for the information included in the table. The risk group may not even be aware that the pricing group is also using the table or may not consider the impact on teams outside of the risk group when changes are made.

In many organizations, certain databases or database tables are considered sources of truth (“source tables”). For example, in a bank, loans may be tracked in a single database that acts as a source of truth. The database may include tables (source tables) that store information such as guarantors, balances, disbursement amounts, disbursement dates, interest rates, due dates, and so forth. A mobile telecommunications company may operate a source of truth database that stores information about customers and their plans, billing information, payment information, etc. Teams or even individual employees may create their own tables based on database tables that are treated as sources of truth.

In some cases, databases and tables that are considered sources of truth are tightly managed. Impacted users are often alerted about changes to source tables in advance of such changes being made, and so forth. By using tables that are treated as sources of truth, developers can more reasonably rely on tables having data in expected formats, including expected fields, containing data that meet well-defined criteria, and so forth. When changes are made, developers can be notified in advance so that they can adapt their applications, reports, and so forth to the changes. Thus, it can be significant to utilize source of truth information when building an application, report, etc. Even in situations where a source table is changed and a developer is unaware of the change, utilizing source tables can nevertheless be advantageous as doing so makes it easier to troubleshoot why a downstream process, report, application, etc., no longer works as expected.

However, there can be significant challenges when working with data from a source table. For example, someone may have already created an intermediate table that applies certain transformations, filters, etc., that are useful for the application or report. By utilizing the source of truth instead, developers may need to recreate such transformations, filters, and so forth. Often, it can be difficult to determine how to get from the information in the source table to a desired result (e.g., to a target table). A significant hurdle can be that developers of a target table may not even be aware of which table or tables an intermediate table is built from. Even if developers do know which tables an intermediate table is built from, developers may not have any insight into transformations, filters, or other operations that are applied to construct the intermediate table.

For example, an intermediate table that is built from a source table or multiple source tables can apply normalization operations such as converting dates to a certain format, converting text to all uppercase, joining data across tables, etc. Other examples of transformations can include, for example and without limitation, aggregation operations (such as summing up sales figures by month), adding information such as geographical coordinates (e.g., based on address fields), splitting (e.g., splitting a field that includes first and last name into separate first name and last name fields), and so forth.

It will be appreciated that a wide array of operations can be carried out to create an intermediate table. Operations on data can be relatively simple, for example copying a subset of columns from one table to another, or can be complex, involving significant text and/or mathematical conversions, and in some cases even generating new data based on data in a table and data obtained from an external source, such as providing a zip code from a database table record to an external service via an API in order to obtain a current weather condition, time zone, etc. Operations can be carried out in a database-centric language, such as SQL. Operations can, additionally or alternatively, use other languages such as Python, PERL, Lua, Ruby, Rust, and so forth.

In the case of SQL scripts, there is a wide range of functions that can be applied to transform data. For example, text functions can include CONCAT( ) to concatenate strings, SUBSTRING( ) to extract a portion of a string, UPPER( ) to convert a string to uppercase, LOWER( ) to convert a string to lowercase, TRIM( ) to remove leading and trailing whitespace, REPLACE( ) to replace portions of a string with another substring, and LENGTH( ) to get the length of a string. Date and time functions can include CURRENT_DATE( ) to return the current date, CURRENT_TIME( ) to return the current time, CURRENT_TIMESTAMP( ) to return the current date and time, DATEADD( ) to add a specified amount of time to a date, DATEDIFF( ) to return the difference between two dates, FORMAT( ) to format a date according to a specified format, YEAR( ) to extract a year from a given date, and so forth. Numeric functions can include, for example, ABS( ) to return the absolute value of a number, CEILING( ) to return the smallest integer greater than or equal to a given number, FLOOR( ) to return the largest integer less than or equal to a given number, ROUND( ) to round a number to a specified number of decimal places, SQRT( ) to return the square root of a number, POWER( ) to return a number raised to the power of another number, MOD( ) to return the remainder of a division operation, and so forth. Aggregate functions can include, for example, COUNT( ) to return the number of rows that match a specified condition, SUM( ) to return the sum of a numeric column, AVG( ) to return the average value of a numeric column, MIN( ) to return the minimum value in a set, MAX( ) to return the maximum value in a set, and so forth.

Other functions can be used additionally or alternatively. Moreover, certain transformations may be carried out in other programming languages, such as Python, Java, JavaScript, Ruby, and so forth. In some cases, databases may not be SQL databases. For example, a database can be a NoSQL database, object database, or any other type of data store. These possibilities add to the complexity associated with reverse engineering.

As described herein, reducing or eliminating reliance on intermediate tables presents a great deal of challenges. When there is little or no documentation, documentation is incomplete or inaccurate, source code is not available, and so forth, developers may be faced with little choice but to either start from scratch or attempt to reverse engineer operations (e.g., to determine which operations were used to populate an intermediate table) and table dependencies (e.g., to determine which tables depend on which other tables). Reverse engineering can involve figuring out how data stored in intermediate tables is produced, which may be non-obvious and may involve significant data manipulation, filtering, and so forth. Accordingly, there is a need for systems and methods that can be used to reverse engineer the operations needed to utilize information in one or more source tables to produce the outputs in a target table. Described herein are approaches that can be used for automatic reverse engineering, which can significantly simplify the task of migrating from reliance on one or more intermediate tables to instead using source tables.

### Automatic Reverse Engineering

Query tracking can be a useful tool for reverse engineering. As described herein, tables, applications, reports, and so forth are often built from or rely on intermediate tables rather than or in addition to source tables. This presents a wide variety of potential issues, as intermediate tables may not be stable over time. For example, what is included in intermediate tables may change or how fields are populated or formatted may change (e.g., a field may switch from using the case in a source table to using only uppercase letters by applying an UPPER( ) function when populating the field).

Logging database queries can enable automatic reverse engineering even when source code, documentation, and so forth are unavailable. In some implementations, the approaches herein log database queries. For example, a logging system or module can be configured to capture all or some queries (e.g., insert, update, delete) executed against one or more database tables. In some implementations, the log data can include various information such as query type (e.g., insert, update, delete), timestamp of the execution, name or other identifier of a user or process executing the query, affected rows count, and so forth. In some implementations, the log data includes query text. Query text can enable more detailed analysis. However, logging entire queries has several potential downsides, such as performance overhead associated with writing logs, increased storage requirements arising from the need to store large logs, potential for sensitive data exposure, and so forth. Thus, in some implementations, query text is not included in the logs or is not included by default. In some implementations, only certain query text is logged. For example, query text associated with certain users or processes can be logged, while other query text is not logged. For example, if a process to be reverse engineered is always run by a particular user account, queries originating from that user account can be logged including the query text, while other queries from other user accounts may not be logged or may be logged but not include the query text.

In some implementations, the approaches herein are used to analyze logs to determine how to achieve particular outputs (e.g., how to obtain particular intermediate tables, target tables, intermediate columns, target columns, etc.). For example, given a set of queries that have been executed, a machine learning model can determine what operations were performed to get to a set of outputs. In some implementations, the machine learning model comprises a large language model (LLM), and the LLM can be configured to output a script (e.g., an SQL script) that can be used to extract data from a source table and transform it into a set of outputs for a target table. In some implementations, the outputs include actual values in a database table (e.g., in a target table or intermediate table). In some implementations, metadata or column statistics are used. For example, a column can be analyzed to determine its type, to determine whether values contain mixed case, only uppercase, or only lowercase letters, to determine the length of strings (e.g., a column for zip code may contain string values where the strings have length five).

The approaches herein can be used to reverse engineer operations used to determine the contents of an intermediate table from the source table(s) on which it depends. As described herein, a large language model or other machine learning model (generally, an ML model) can be used to generate a script that outputs a set of operations that can be used to produce a target table.

There are several possible approaches to reverse engineering, which may involve more or less complexity, more or less input or intervention on the part of a user, and so forth. For example, a reverse engineering process can involve determining what operations were performed to produce a target table from its sources, but may not further simplify or combine operations. A more complex or comprehensive reverse engineering process can determine possible changes that can reduce or eliminate dependence on intermediate results, tables, etc.

An LLM can be provided with various information that can be useful for reverse engineering. For example, it can be significant for the LLM to have access to information such as language structures, database structures, and so forth. For example, providing information to the LLM about which tables exist, what fields they contain, and so forth can be important for reverse engineering purposes. The amount and nature of such supporting information can vary depending on how a reverse engineering process is carried out. For example, when using database logs for reverse engineering, more detailed supporting information (e.g., about specific fields in database tables) may be needed or useful when the logs do not include the actual queries that were executed, as compared to when the database logs do include the actual queries. For example, an LLM may be able to infer that a ten character alphanumeric sequence is an account number, particularly if provided with examples of account numbers, but may need to be provided with information indicating the name of a field in a database table that stores account numbers. In contrast, if the database logs include the actual queries, the name of the field that stores account numbers may be present in the logs, and hence information about the fields in particular tables may not be needed. However, it will be appreciated that detailed information about the structure of database tables may still be beneficial even when actual queries are included in logs. For example, there may be other fields in a source table that contain information that is better suited to determining the content for a target table. As an example, a target table may have a field for a masked social security number (e.g., XXX-XX-1234) and may currently pull such information from a field with an unmasked social security number (e.g., 123-12-1234) and then apply an operation to mask the unmasked social security number, but a source table may already have a masked social security number field available.

In some implementations, a system can be configured to analyze database logs and produce a set of operations (e.g., SQL queries) corresponding to the information in the database logs. In some implementations, the system is provided with information about a target table, such as what fields are included in the target table and one or more examples of what the data in the target table looks like, which can help a machine learning model to analyze logged information and generate a set of operations to reproduce the logged operations. Consider the following examples of prompts for generating a set of operations:

No examples of desired outputs:

Analyze the attached database logs to determine a set of operations used for populating fields in a target database containing fields for full name, address, and zip code.

One example of desired outputs:

Analyze the attached database logs to determine a set of operations used for populating fields in a target database containing fields for full name, address, and zip code. As an example, consider the following JSON: [{“FullName”:“John Smith”,“Address”:“10489 Corry Parkway”,“ZipCode”:54267}]

Three examples of desired outputs:

Analyze the attached database logs to determine a set of operations used for populating fields in a target database containing fields for full name, address, and zip code. Examples of data in the target table include:

```
{
  “FullName”: “John Smith”,
  “Address”: “10489 Corry Parkway”,
  “ZipCode”: 54267
}
{
  “FullName”: “Jane Smith”,
  “Address”: “317 Claremont Point”,
  “ZipCode”: 89724
}
{
  “FullName”: “Allen Jones”,
  “Address”: “217 Texas Avenue”,
  “ZipCode”: 18976
}
```

Other information can be provided additionally or alternatively. For example, in some implementations, a prompt can specify data types of fields (e.g., text, numeric, binary, Boolean).

In some implementations, database logs are provided to the LLM along with information about the target table (e.g., fields in the target table, example values in the target table). In some implementations, executable code (e.g., one or more scripts) for populating the target table are provided to the LLM in addition to or as an alternative to information about the target table. Providing the executable code used to populate the target table can essentially operate to eliminate a step from the reverse engineering process, as the final set of operations to be executed is already known. Executable code can indicate which fields in one or more source tables and/or intermediate tables are used to populate the target table. While providing the executable code for populating the target table can provide certain benefits, such executable code is not necessary. Advantageously, the approaches herein can operate even without such executable code being provided, which can be important, for example, in circumstances where such executable code is not available. For example, source code may have been lost and only binaries or bytecode may be available.

A reverse engineering process can include reverse engineering all operations carried out to produce the outputs in the target table, including operations (e.g., all operations or relevant operations) on intermediate tables utilized when populating the target table. In some implementations, the process can end after such reverse engineering is complete. For example, the LLM can output a script that includes all the operations for producing the target table as currently implemented, including operations for populating intermediate tables used in populating the target table.

While a script that shows all operations can be beneficial, it can be desirable to generate a script that does not utilize or depend upon intermediate tables. As an example, a target table may have a field for name that includes both first and last name together, in uppercase (e.g., “JOHN SMITH”), which is populated from an intermediate table having an uppercase first name field (e.g., “JOHN”) and an uppercase last name field (e.g., “SMITH”), which may be populated from a source table having a first name field (e.g., “John”) and a last name field (e.g., “Smith”). Depending upon the intermediate table may confer little or no benefit. It can thus be desirable to simplify a set of operations from, for example:

INSERT INTO intermediateTable (first, last) SELECT
UPPER(firstName), UPPER(lastName) as first, last;
INSERT INTO targetTable (name) SELECT CONCAT(first, “ ”, last);
to
INSERT INTO targetTable (name) SELECT
CONCAT(UPPER(firstName), “ ”, UPPER(lastName));

In some implementations, generating a final script or set of operations that does not involve intermediate database tables is carried out as a multi-stage process. For example, in a first stage, a machine learning model (e.g., a large language model (LLM)) can generate operations that produce the data in the target database table and that utilize intermediate table(s) in doing so. The generated operations can be used to generate an input for a second machine learning model, which can be the same model or a different model, to generate a second set of operations to generate the data in the target database table from one or more source tables without involvement of intermediate tables, or with reduced involvement of intermediate tables (e.g., decreasing from dependence on N intermediate to dependence on M intermediate tables, where N and M are integers and M is less than N).

### Source Table Change Detection

In some implementations, the approaches herein are configured to monitor one or more source tables to detect changes. For example, the approaches herein can be used to detect record insertions, record updates, record deletions, and so forth. In some implementations, changes to the table structure itself, such as the format of columns, addition of columns, removal of columns, etc., are monitored. Changes can be monitored continuously or periodically. In some implementations, affected rows are analyzed to determine which target table(s) are impacted by the changes to the source table. In some implementations, the approaches herein utilize predefined mapping rules to determine how source changes translate into target updates.

Understanding changes to a source table can have significant implications. For example, if an existing column in a source table has its name changed, this can break updates to the target table as queries that rely on the old column name may fail when executed. As another example, if the format of a column is changed, this can cause updates to the target table to fail or include unexpected or incorrect information. For example, if a field was originally defined as a string that contained true and false values, and a process checks for string values of “TRUE” and “FALSE,” the process can fail if the field's type is subsequently changed to Boolean.

In some implementations, a machine learning model (e.g., an LLM) refactors queries in response to changes in a table. For example, if additional columns are added to a table, but those columns are not needed for a particular process, application, report, etc., a query can be modified so that those additional columns are not pulled. As an example, if a query was originally “SELECT*FROM ORDERS WHERE ORDER_DATE>=‘2025-01-01’,” the query can be refactored as “SELECT ORDER_ID, CUSTOMER_ID, ORDER_DATE, SUBTOTAL FROM ORDERS WHERE ORDER_DATE>=‘2025-01-01’” if only the ORDER_ID, CUSTOMER_ID, ORDER_DATE, and SUBTOTAL columns are used in subsequent operations. In some implementations, refactoring is performed even if underlying source tables do not change. For example, a user can request refactoring, which can simplify queries, reduce computational loads, and so forth. In some implementations, refactoring is carried out as part of a reverse engineering process.

### Data Integrity

There can be many benefits to the approaches described herein. For example, the approaches herein can be used to improve data integrity and quality. By tracking how tables are populated and updated, organizations can ensure higher data quality and integrity. For example, in some implementations, a machine learning model is trained to identify unusual reads, updates, insertions, deletions, and so forth in a database table. For example, a machine learning model can be trained on historical logs of database accesses and modifications, and can analyze logs to determine if the logs reflect any anomalous behavior. Deviations from normal behavior may be benign, potentially harmful, or even malicious. For example, logs may change because a new application or report was recently deployed, because a developer or administrator made a configuration or coding error, or because a nefarious actor is attempting to modify, corrupt, or exfiltrate data. For example, if there is an unexpected and unexplained uptick in database reads, this may indicate that an attacker, which may be internal or external to the organization, is attempting to steal information.

In some implementations, the systems and methods herein are configured to identify a source of unusual activity. For example, a system can be configured to determine if unusual activity is due to a change in an existing job, the creation of a new job, etc. The systems and methods herein can be configured to determine if activity originates from an outside source or other unusual source (e.g., an internal system that isn't expected to access such data or a user account that typically would not access such data, which may indicate that a system or account has been compromised by an outside actor). In some implementations, the systems and methods herein determine if data is sent to an outside source or other unusual source, which can indicate an attempt to exfiltrate data.

### Management and Efficiency

The approaches herein can, additionally or alternatively, improve efficiency, management of database queries, and so forth. For example, in some implementations, the approaches herein utilize predictive analytics to predict data refresh delays. For example, businesses and other organizations often have predictable events in which there may be an unusually large number of changes to a database, which can result in delayed availability of current data. For example, a wireless telecommunications company may experience a dramatic surge in device changes when a new model of a popular smartphone is released. Companies may see significant upticks in sales when the holiday season arrives or as businesses come close to the end of their fiscal year and groups look to spend remaining funds. Such changes in volume can result in delays in updating affected database tables.

In some implementations, a machine learning model is trained to predict data refresh delays. For example, a machine learning model can be trained on historical data such as historical database operations (e.g., create, update, delete operations). In some implementations, the machine learning model can be trained using, for example, news reports, press releases, or the like. For example, the machine learning model may ingest a press release announcing the release of a new smartphone, and the model can predict that there will be data refresh delays when the new smartphone becomes available to the public for purchase.

Such predictions can enable improved management of jobs that run against a database or particular table of a database. For example, if a table normally updates by 10 PM but due to increased volume isn't expected to be fully updated until 11:30 PM, a job that depends on the table can be delayed to allow sufficient time for the table to finish updating.

In some implementations, a machine learning model is used to predict delays in table updates. For example, a machine learning model can be trained to predict delays based on historical data. The historical data can include, for example, data that indicates table update completion times for various dates. In some implementations, the historical data can include other information such as the dates of sales or other promotions, dates of product announcements, product release dates, and so forth. For example, an order database table can be expected to have significantly more activity on days when a new flagship smartphone device becomes available for pre-order.

A system can be provided with information that can be indicative of future database table update delays. In some implementations, a system is configured to ingest information such as blog posts, press releases, etc., to identify dates (e.g., release dates, preorder dates, etc.) when there may be higher than usual activity on a database table. In some implementations, information from internal systems can be used for predicting delays in database table updates. For example, a company may configure its online store to permit orders starting on a particular date, or a product page for a new product may indicate when the product will be available in stores or when it will ship to customers.

In some cases, a database table update may be delayed for other reasons. For example, at the end of a month, quarter, fiscal year, etc., there may be a larger than normal volume of reports that need to be run, which can result in delays due to atypically high demand for computing resources. Large numbers of intermediate tables, and potentially complex dependencies among intermediate tables, source tables, and target tables can further introduce delays as computing resources are tied up populating a large number of tables, at least some of which could be eliminated or have their population processes simplified significantly.

### Table Creation

Reducing or eliminating the use of intermediate tables can have many advantages as described herein, for example simplifying queries, reducing the likelihood that processes break or produce inaccurate outputs, and so forth. However, in some cases, intermediate tables can be valuable because, for example, they may contain data that is used by many different processes. As a simple example, consider a source table that stores addresses including zip codes. Multiple processes may utilize the address data (and potentially one or more external data sources) to determine zip+4 codes. If every report, application, process, etc., that utilizes zip+4 has to determine zip+4 based on the address data, the same or similar efforts may be duplicated multiple times. Moreover, processes for determining zip+4 may not be implemented consistently and some may contain errors that result in flawed determinations. Thus, it may be desirable to modify a source table to include a field for zip+4 (or a field that includes the four digits that are appended to a zip code to make a zip+4 code). As another example, a company may have multiple reports, processes, etc., that target customers who have made a purchase in the last six months. It can be advantageous to create a table that includes only those customers who have made purchases in the last six months, as otherwise every report, process, etc., that utilizes such information will have to perform queries that select only customers with purchases in the last six months or otherwise perform filtering operations to identify the relevant customers, again resulting in duplication of efforts, increased computing resource demands, and so forth.

In some implementations, the systems and methods herein can be used to identify a need or benefit to modifying existing tables (for example, to add one or more additional fields to an existing table), creating new tables, and so forth. For example, a system can be configured to access database logs, scripts, or both to determine which transformations, filters, etc., are commonly used, and can recommend that fields and/or tables be created so that data is readily available without a need for each application, report, etc., to include code for performing such transformations or filtering. In some implementations, the systems and methods herein generate vector embeddings of queries, for example using a string encoder, and similar operations can be identified based on similarity of the vector embeddings, for example using a metric such as Euclidean distance, Manhattan distance, cosine similarity, dot product similarity, or any other suitable similarity metric.

While described herein largely in terms of relational databases and typical features of such databases such as tables, it will be appreciated that the approaches herein are not limited to relational databases and can be applied to, for example, NoSQL databases, object databases, text files, files organized within a file system, and so forth. Generally, operations such as reads and writes can be monitored and used for reverse engineering, identifying integrity issues, identifying delay issues, and so forth.

### Machine Learning

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a neural network with multiple input nodes that receive inputs, such as database log data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the inputs. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes inputs and corresponding desired outputs, such as log data and labels indicating if the log data indicates abnormal activity. A representation of the log data (or other input) can be provided to the model. Output from the model can be compared to the desired output for that input and, based on the comparison, the model can be modified, such as by changing weights between nodes of the neural network or parameters of the functions used at each node in the neural network (e.g., applying a loss function). After training, the model can be used to evaluate new inputs, such as new database logs.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus may be created by extracting text from online web pages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpora may be, e.g., fine-tuned by further training using specific training samples. The specific training samples can be used to generate language in a certain style or in a certain format. For example, the ML model can be trained to generate a blog post having a particular style and structure with a given topic. As another example, an ML model can be used in programming applications; for example, an ML model can be trained to generate code, simplify code, generate explanations of code, etc.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

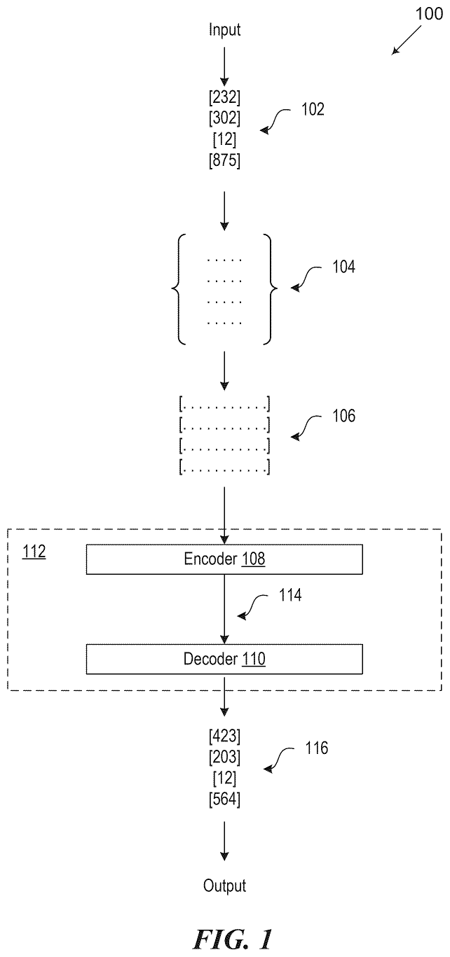

FIG. 1 is a block diagram of an example transformer 112. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 112 includes an encoder 108 (which can comprise one or more encoder layers/blocks connected in series) and a decoder 110 (which can comprise one or more decoder layers/blocks connected in series). Generally, the encoder 108 and the decoder 110 each include a plurality of neural network layers, at least one of which can be a self-attention layer. The parameters of the neural network layers can be referred to as the parameters of the language model.

The transformer 112 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 112 is trained to perform certain functions on other input formats than natural language input. For example, the input can include objects, images, audio content, video content, or a combination thereof.

The transformer 112 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 1 illustrates an example of how the transformer 112 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 1, a short sequence of tokens 102 corresponding to the input text is illustrated as input to the transformer 112. Tokenization of the text sequence into the tokens 102 can be performed by some pre-processing tokenization module such as, for example, a byte-pair encoding tokenizer (the “pre” referring to the tokenization occurring prior to the processing of the tokenized input by the LLM), which is not shown in FIG. 1 for simplicity. In general, the token sequence that is inputted to the transformer 112 can be of any length up to a maximum length defined based on the dimensions of the transformer 112. Each token 102 in the token sequence is converted into an embedding vector 106 (also referred to simply as an embedding 106). An embedding 106 is a learned numerical representation (such as, for example, a vector) of a token that captures some semantic meaning of the text segment represented by the token 102. The embedding 106 represents the text segment corresponding to the token 102 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 106 corresponding to the “write” token will be closer to another embedding corresponding to the “jot down” token in the vector space as compared to the distance between the embedding 106 corresponding to the “write” token and another embedding corresponding to the “summary” token.

The vector space can be defined by the dimensions and values of the embedding vectors. Various techniques can be used to convert a token 102 to an embedding 106. For example, another trained ML model can be used to convert the token 102 into an embedding 106. In particular, another trained ML model can be used to convert the token 102 into an embedding 106 in a way that encodes additional information into the embedding 106 (e.g., a trained ML model can encode positional information about the position of the token 102 in the text sequence into the embedding 106). In some examples, the numerical value of the token 102 can be used to look up the corresponding embedding in an embedding matrix 104 (which can be learned during training of the transformer 112).

The generated embeddings 106 are input into the encoder 108. The encoder 108 serves to encode the embeddings 106 into feature vectors 114 that represent the latent features of the embeddings 106. The encoder 108 can encode positional information (i.e., information about the sequence of the input) in the feature vectors 114. The feature vectors 114 can have very high dimensionality (e.g., on the order of thousands or tens of thousands), with each element in a feature vector 114 corresponding to a respective feature. The numerical weight of each element in a feature vector 114 represents the importance of the corresponding feature. The space of all possible feature vectors 114 that can be generated by the encoder 108 can be referred to as the latent space or feature space.

Conceptually, the decoder 110 is designed to map the features represented by the feature vectors 114 into meaningful output, which can depend on the task that was assigned to the transformer 112. For example, if the transformer 112 is used for a translation task, the decoder 110 can map the feature vectors 114 into text output in a target language different from the language of the original tokens 102. Generally, in a generative language model, the decoder 110 serves to decode the feature vectors 114 into a sequence of tokens. The decoder 110 can generate output tokens 116 one by one. Each output token 116 can be fed back as input to the decoder 110 in order to generate the next output token 116. By feeding back the generated output and applying self-attention, the decoder 110 is able to generate a sequence of output tokens 116 that has sequential meaning (e.g., the resulting output text sequence is understandable as a sentence and obeys grammatical rules). The decoder 110 can generate output tokens 116 until a special [EOT] token (indicating the end of the text) is generated. The resulting sequence of output tokens 116 can then be converted to a text sequence in post-processing. For example, each output token 116 can be an integer number that corresponds to a vocabulary index. By looking up the text segment using the vocabulary index, the text segment corresponding to each output token 116 can be retrieved, the text segments can be concatenated together, and the final output text sequence can be obtained.

In some examples, the input provided to the transformer 112 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Implementations

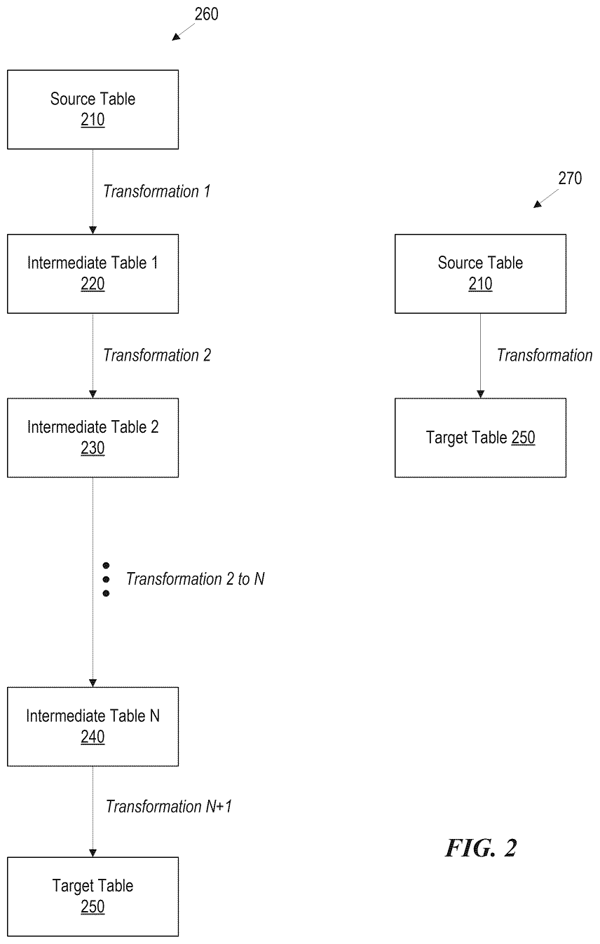

FIG. 2 is a block diagram that illustrates using intermediate tables and source tables to determine information for a target table according to some implementations. Flow 260 illustrates an example of a process in which a source table 210 undergoes a first transformation to generate data for a first intermediate table 220. The data in the first intermediate table 220 is then transformed to generate data for a second intermediate table 230. There can be any number of transformations, generally denoted N, where N is equal to or greater than one. After N transformations, intermediate table N 240 is generated. A target table 250 can be populated based on data pulled from intermediate table N 240. While a single flow of tables is illustrated in flow 260, it will be appreciated that other configurations are possible. For example, a target table can be built from a plurality of intermediate tables, a plurality of source tables, or any combination of source tables and intermediate tables. A target table can depend directly upon data from any combination of source tables, intermediate tables, or both.

By utilizing the approaches described herein, the flow 260 can be converted into the flow 270. In flow 270, data is pulled from a source table 210 and can undergo one or more transformations to produce outputs for populating target table 250. While only one source table is shown in the flow 270, it will be appreciated that in practice there can be any number of source tables used to generate the target table 250 in the flow 270. Moreover, in some implementations, not all intermediate tables are eliminated and the flow 270 may be a simplified flow that still includes one or more intermediate tables. As described herein, this can be advantageous as source table 210 can be a source of truth that is maintained, documented, and so forth. Developers may be notified when there are planned changes to the source table 210. In contrast, the intermediate tables may be built by specific teams for particular purposes. Intermediate tables may not be fully documented, may undergo significant changes over time, and so forth. For example, the transformation logic used to populate an intermediate table may change without warning or in unexpected ways, which can break target table 250. By utilizing source table 210 directly, the likelihood that target table 250 becomes broken, outdated, etc., can be reduced. Moreover, by using source table 210 directly, certain transformations, additional database queries, and so forth can be avoided. For example, in FIG. 2, only single table dependencies are illustrated. However, in some cases, a target table may be generated by pulling data from multiple tables, intermediate tables may be built from multiple source tables and/or other intermediate tables, and so forth. For example, to populate target table 250, data may be pulled from both intermediate table N 240 and another intermediate table, such as intermediate table 1 220 or any other table, which can be a source table or another intermediate table. Pulling directly from source table 210 can reduce or eliminate the need to pull data from multiple tables.

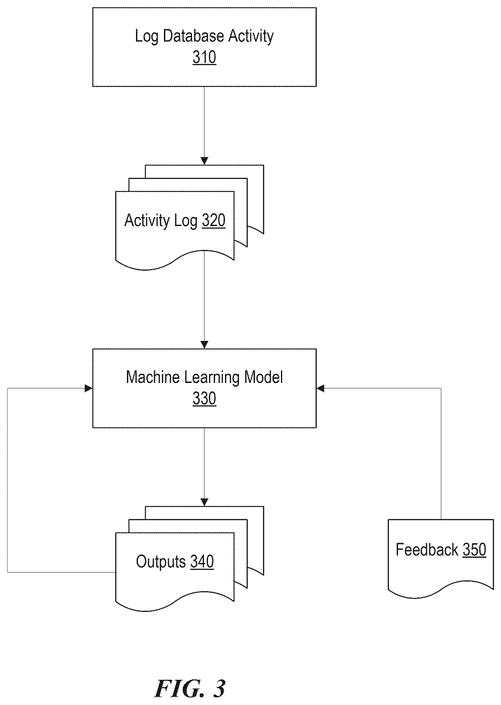

FIG. 3 is a diagram that shows an example using a machine learning model to analyze database activity according to some implementations. At operation 310, a system can log activity occurring on or against one or more database tables. The logs can be stored in activity log 320, which may comprise one or more files or other data stores (e.g., one or more database tables). A machine learning model 330 can accept the activity log 320, a portion thereof, or data based on the activity log 320 as an input, and can produce outputs 340 based on the input. The outputs 340 can include, for example, a script to reproduce one or more operations observed in or derived from the activity log 320. In some implementations, the machine learning model 330 receives feedback 350. The machine learning model 330 can undergo fine-tuning or further training based on the outputs 340 and the feedback 350. For example, the feedback 350 can indicate whether the outputs 340 performed as expected, had certain errors, and so forth.

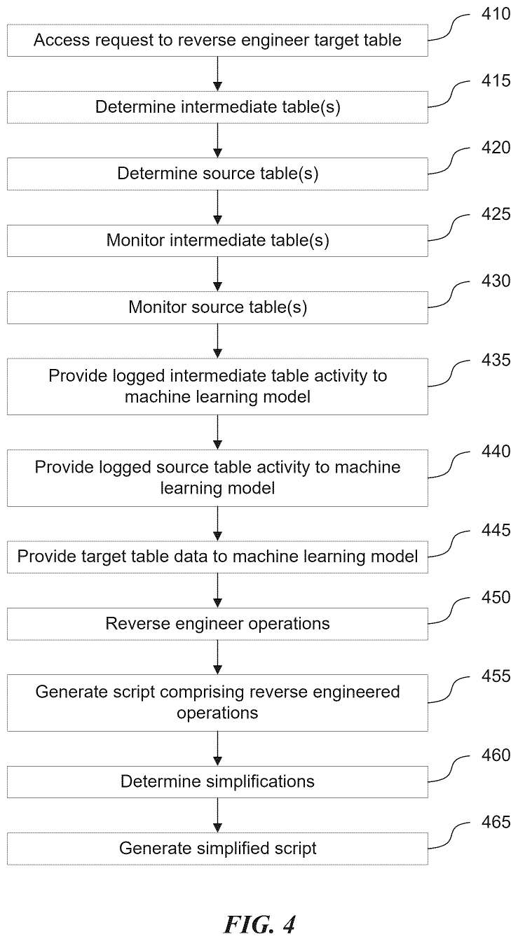

FIG. 4 is a flowchart that illustrates an example reverse engineering process according to some implementations. The process illustrated in FIG. 4 can be performed by one or more computer systems (generally, “system”).

At operation 410, the system can access a request to reverse engineer a target table. For example, a user can submit a request (e.g., via a web interface, application, etc.) to reverse engineer the target table. The target table can be created based at least in part on data retrieved from one or more intermediate tables. The one or more intermediate tables can be tables that are populated based on data pulled from other intermediate tables, one or more source tables, or both.

At operation 415, the system can determine intermediate table(s) used to populate the target table. For example, the system can access a script (e.g., a script provided by the user) that includes one or more queries against one or more intermediate tables.

At operation 420, the system can determine source table(s) used to populate the target table, one or more intermediate tables, or both. For example, the target table may be populated only from one or more intermediate tables or from one or more intermediate tables and one or more source tables. Intermediate tables can be populated from one or more source tables, one or more other intermediate tables, or both.

At operation 425, the system can monitor the intermediate table(s) to determine operations (e.g., CRUD operations) that occur on the intermediate table(s). This information can be logged for further analysis.

At operation 430, the system can monitor the source table(s) to determine operations (e.g., CRUD operations) that occur on the source table(s). This information can be logged for further analysis.

At operation 435, the system can provide the logged intermediate table activity to a machine learning model, which can be, for example, a large language model or other suitable machine learning model. At operation 440, the system can provide the logged source table activity to the machine learning model. At operation 445, the system can provide target table data to the machine learning model. In some implementations, the system does not utilize the target table data. For example, the system can, additionally or alternatively, utilize a current script for generating the target table data. The current script can specify one or more intermediate tables (and optionally, one or more source tables) used to populate the target table.

At operation 450, the system can reverse engineer operations to get from the source table(s) to the target table, including any steps used to get from the source table(s) to the intermediate table(s). For example, the system can provide the logged intermediate table operations, the logged source table operations, and the target table data and/or script to a machine learning model (e.g., an LLM), and the machine learning model can determine, based on the logged operations, steps taken to get from the source table(s) to the target table, which can include operations performed to populate any intermediate tables.

At operation 455, the system can generate a script comprising reverse engineered operations. For example, the outputs of the machine learning model can be, or can be used to generate, a script (e.g., an SQL script, JavaScript script, Python script, etc.) that can perform the operations used to populate the target table.

At operation 460, the system can determine simplifications and/or eliminate intermediate tables from the script. For example, the system can transform the script by combining operations, modifying operations to pull data from source tables rather than intermediate tables, and so forth.

At operation 465, the system can generate a simplified script. In some implementations, the simplified script eliminates reliance on any intermediate tables and instead populates the target table based on data pulled only from one or more source tables.

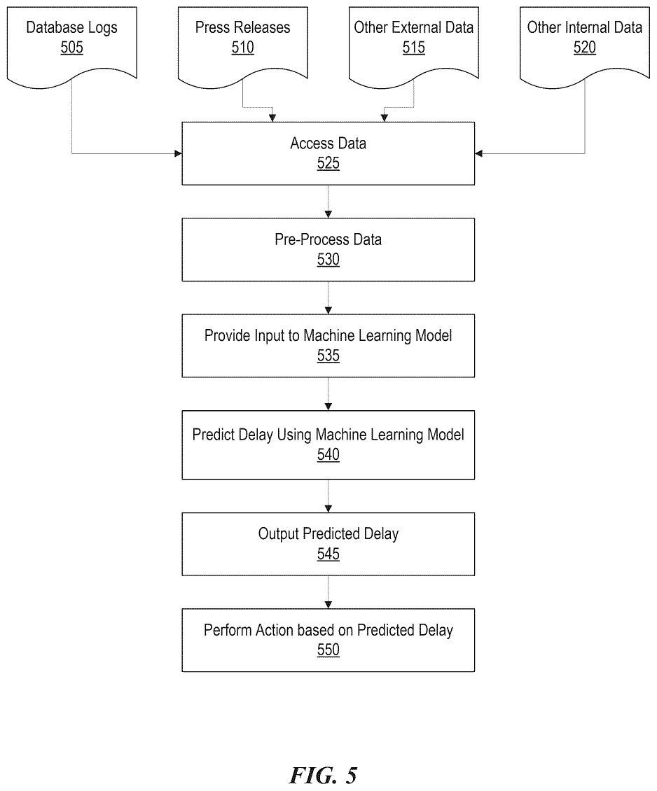

FIG. 5 is a flowchart that illustrates an example delay prediction process according to some implementations. At operation 525, a system can access various data that can be used as the basis for inputs to a machine learning model. The data can include, for example, database logs 505, press releases 510, other external data 515, and/or other internal data 520. Database logs 505 can include information such as the volume of transactions occurring on a database table over time (e.g., hourly, daily, weekly, etc.). Press releases 510 can include information such as press releases by manufacturers of products a company sells (e.g., announcements of new smartphones, tablets, etc.). Other external data 515 can include information such as blog posts, social media posts/comments, and so forth. For example, social media activity may indicate interest in a new product, positive coverage may correlate with high demand, poor coverage may correlate with relatively low demand, and so forth. Other internal data 520 can include, for example, press releases by a company announcing availability for a new product or service, information about pre-orders or shipping dates, and so forth.

At operation 530, the system can pre-process the data, for example to convert it into a format that can be used as an input to a machine learning model. In some implementations, pre-processing can include extracting information from the data. In some implementations, pre-processing utilizes machine learning. For example, a press release can be provided to a large language model along with instructions to extract a product release date from the press release. At operation 535, the system can provide an input to a machine learning model that is configured to predict database update delays. At operation 540, the machine learning model can predict a database update delay based on the provided input. At operation 545, the system can output the predicted delay. At operation 550, the system can perform an action based on the predicted delay. For example, if a new product is launching on a given day, the system can delay a scheduled sales reporting job so that a database table on which the sales reporting job depends can have sufficient time to update before the sales reporting job is run.

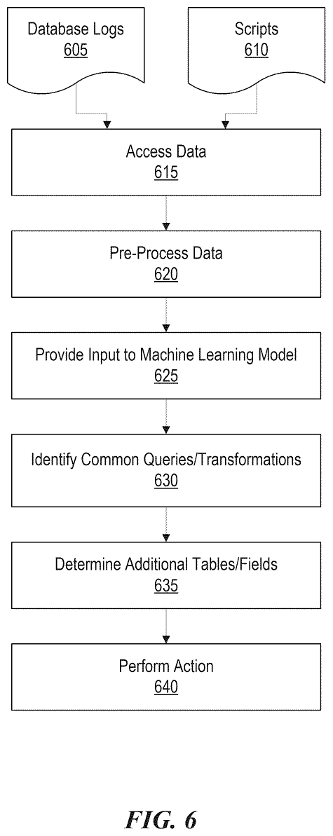

FIG. 6 is a flowchart that illustrates an example process for analyzing queries and determining if there is a need/benefit for additional tables, fields, or both according to some implementations. At operation 615, a system can access data, such as database logs 605 and scripts 610. Database logs 605 can include information about operations that occur on one or more database tables. Scripts 610 can include scripts for querying database tables, transforming data, and so forth. At operation 620, the system can pre-process the data, for example to transform the data into a standardized format. In some implementations, the system can analyze a script of the scripts 610 to identify specific operations included in the script. At operation 625, the system can generate an input for a machine learning model and can provide the input to the machine learning model. At operation 630, the system can identify common queries, transformations, and so forth. It will be appreciated that operations may accomplish similar tasks or produce functionally the same outputs while being constructed differently. Thus, in some implementations, the system can use techniques such as cosine similarity or another similarity measure to identify similar queries. In some implementations, the machine learning model can be an embedding model configured to receive inputs and generate vector embeddings of the inputs, which can be compared to identify similar vector embeddings. At operation 635, the system can, based on the identified common queries and/or transformations, determine one or more additional tables and/or fields that could be advantageously added to a database or to an existing database table. For example, if certain data transformations are commonly used, the system can identify that there may be a benefit to adding fields to an existing database table that include the commonly used data transformations. If certain filters, joins, etc., are commonly used, the system can determine that there may be a benefit to creating a new table that can be queried instead of querying a source table directly. At operation 640, the system can perform an action. The action can include, for example, outputting the determinations so that a user can review the outputs, generating one or more recommendations for review by the user, and/or automatically creating a new database table or adding a field to an existing table.

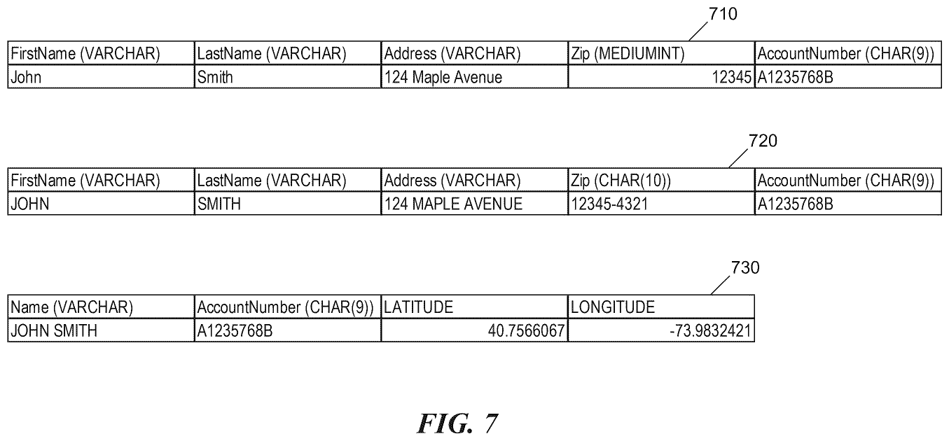

FIG. 7 illustrates an example of transformations that can be performed in some implementations. In FIG. 7, a source table 710, intermediate table 720, and target table 730 are illustrated, with a single record shown for each table. In an original process (e.g., a process carried out before utilizing the approaches described herein, a system can produce the record in target table 730 by concatenating the FirstName and LastName fields in intermediate table 720, slecting the AccountNumber field from intermediate table 720, and using the Address and/or Zip fields to determine values for latitude and longitude, for example using an external service. The intermediate table 720 can be populated by transforming the FirstName, LastName, and Address fields in source table 710 to uppercase, selecting the AccountNumber field, and determining a zip+4 code (formatted as a character sequence in intermediate table 720) from the Zip field and Address field in source table 710. For example, the system can provide the Address and Zip listed in source table 710 to an external service to determine the zip+4 code to be populated in intermediate table 720.

While populating target table 730 from intermediate table 720 and populating intermediate table 720 from source table 710 produces the desired outputs, it is possible to avoid using intermediate table 720 and instead populate target table 730 using source table 710 directly. For example, a system can populate the name field in target table 730 by applying concatenation and uppercase functions to the FirstName and LastName fields in source table 710, populate the AccountNumber field in target table 730 directly from the AccountNumber field in source table 710, and can determine the Latitude and Longitude values using the address and zip fields in source table 710.

### Computer System

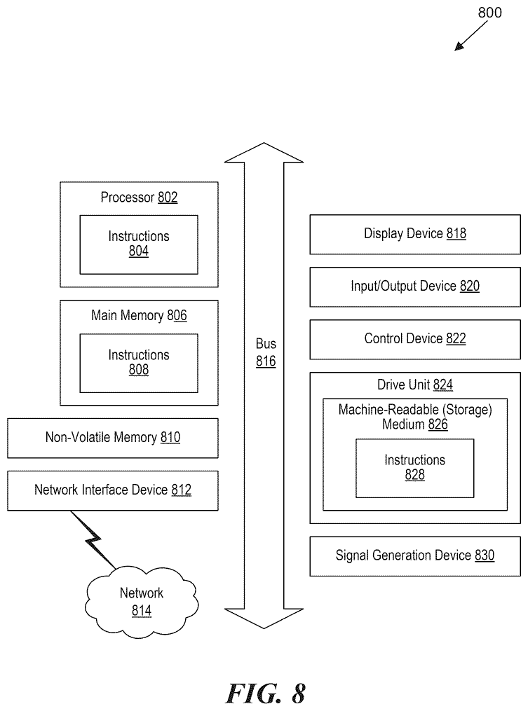

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for reverse engineering, the computer-implemented method comprising:
accessing a request to reverse engineer a target database table;
determining at least one intermediate database table, wherein the at least one intermediate database table is used to populate data stored in the target database table;
determining at least one source database table, wherein the at least one source database table is used to populate data stored in the at least one intermediate database table;
monitoring a first plurality of transactions on the at least one intermediate database table to generate first monitoring data, wherein the first monitoring data includes at least two of: a first query type, a first timestamp, a first identifier of a user or process associated with a transaction, or a first number of rows involved in the transaction;
monitoring a second plurality of transactions on the at least one source database table to generate second monitoring data, wherein the second monitoring data includes at least two of: a second query type, a second timestamp, a second identifier of a user or process associated with a transaction, or a second number of rows involved in the transaction;
providing, to a machine learning model, at least a first subset of the first monitoring data and at least a second subset of the second monitoring data;
determining, using the machine learning model and based on an analysis of the first subset of the first monitoring data and the second subset of the second monitoring data, a first set of operations,
wherein the first set of operations is configured to generate the target database table from the at least one source database table, wherein the first set of operations comprises operations for generating at least a portion of the at least one intermediate database table from the at least one source database table and instructions for generating the target database table from the at least one intermediate database table; and
providing the first set of operations to the machine learning model to cause the machine learning model to generate a second set of operations, wherein the second set of operations is configured to generate data in the target database table by executing operations against the at least one source database table and without executing operations against the at least one intermediate database table.

2. A computer-implemented method for reverse engineering, the computer-implemented method comprising:
accessing a request to reverse engineer a target database table;
determining at least one intermediate database table, wherein the at least one intermediate database table is used to populate data stored in the target database table;
determining at least one source database table, wherein the at least one source database table is used to populate data stored in the at least one intermediate database table;
monitoring a first plurality of transactions on the at least one intermediate database table to generating first monitoring data;
monitoring a second plurality of transactions on the at least one source database table to generate second monitoring data;
providing, to a machine learning model, at least a first subset of the first monitoring data and at least a second subset of the second monitoring data; and
determining, using the machine learning model and based on an analysis of the first subset of the first monitoring data and the second subset of the second monitoring data, a first set of operations,
wherein the first set of operations is configured to generate the target database table from the at least one source database table.

3. The computer-implemented method of claim 2, wherein the first set of operations comprises operations for generating at least a portion of the at least one intermediate database table from the at least one source database table and instructions for generating the target database table from the at least one intermediate database table.

4. The computer-implemented method of claim 3, further comprising:
providing the first set of operations to a second machine learning model to cause the second machine learning model to generate a second set of operations, wherein the second set of operations is configured to generate data in the target database table by executing operations against the at least one source database table and without executing operations against the at least one intermediate database table.

5. The computer-implemented method of claim 2, wherein the first plurality of transactions comprises one or more of: create operations, read operations, or update operations, and wherein the second plurality of transactions comprises one or more of: create operations, read operations, or update operations.

6. The computer-implemented method of claim 2, wherein the first subset of the first plurality of transactions and the second subset of the second plurality of transactions are selected based on one or more of: transaction execution time, transaction process identifier, or transaction user identifier.

7. The computer-implemented method of claim 2, wherein determining the at least one intermediate database table is based on target database table information, wherein the target database table information comprises executable code for populating information in the target database table based on data retrieved from an intermediate database table of the at least one intermediate database table.

8. The computer-implemented method of claim 2, wherein determining the at least one intermediate database table is based on target database table information, and wherein the target database table information comprises one or more records stored in the target database table.

9. The computer-implemented method of claim 2, wherein at least one of the first monitoring data or the second monitoring data includes at least two of: a query type, a timestamp, an identifier of a user or process associated with a transaction, or a number of rows involved in the transaction.

10. The computer-implemented method of claim 2, wherein the first monitoring data includes a query executed against the at least one intermediate database table.

11. The computer-implemented method of claim 2, further comprising:
determining a change in a structure of the at least one source database table; and
determining an action to perform in response to the change in the structure of the at least one source database table.

12. The computer-implemented method of claim 2, further comprising:
determining a change in a structure of the at least one source database table; and
estimating, using a predictive model, an impact of the change on the target database table, wherein the impact comprises a change in a resource level used to populate the target database table.

13. The computer-implemented method of claim 12, wherein estimating the impact is based at least in part on a set of mapping rules indicating relationships between the at least one source database table and the target database table.

14. The computer-implemented method of claim 12, wherein the resource level comprises at least one of: a processor utilization, an energy utilization, a memory utilization, or a storage utilization.

15. A system comprising:
at least one hardware processor; and
a non-transitory memory storing instructions which, when executed by the at least one hardware processor, cause the system to:
accessing a request to reverse engineer a target database table;
determining at least one intermediate database table,
wherein the at least one intermediate database table is used to populate data stored in the target database table;
determining at least one source database table,
wherein the at least one source database table is used to populate data stored in the at least one intermediate database table;
monitoring a first plurality of transactions on the at least one intermediate database table to generate first monitoring data;
monitoring a second plurality of transactions on the at least one source database table to generate second monitoring data;
providing, to a machine learning model, at least a first subset of the first monitoring data and at least a second subset of the second monitoring data; and
determining, using the machine learning model and based on an analysis of the first subset of the first monitoring data and the second subset of the second monitoring data, a first set of operations,
wherein the first set of operations is configured to generate the target database table from the at least one source database table.

16. The system of claim 15, wherein the first set of operations comprises operations for generating at least a portion of the at least one intermediate database table from the at least one source database table and instructions for generating the target database table from the at least one intermediate database table.

17. The system of claim 16, wherein the instructions are further configured to cause the system to:
providing the first set of operations to a second machine learning model to cause the second machine learning model to generate a second set of operations, wherein the second set of operations is configured to generate data in the target database table by executing operations against the at least one source database table and without executing operations against the at least one intermediate database table.

18. The system of claim 15, wherein the first plurality of transactions comprises one or more of: create operations, read operations, or update operations, and wherein the second plurality of transactions comprises one or more of: create operations, read operations, or update operations.

19. The system of claim 15, wherein the first subset of the first monitoring data and the second subset of the second monitoring data are selected based on one or more of: transaction execution time, transaction process identifier, or transaction user identifier.

20. The system of claim 15, wherein determining the at least one intermediate database table is based on target database table information, wherein the target database table information comprises executable code for populating information in the target database table based on data retrieve from an intermediate table of the at least one intermediate database table.
